(19) United States
(12) Patent Application Publication
(10) Pub. No.: US 2004/0155424 A1
(43) Pub. Date: Aug. 12, 2004

(54) Front steer axle suspension with inclined air springs

(76) Inventors: William J. Hicks, Muskegon, MI (US); Thomas A. McKenzie, Spring Lake, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/472,292

(22) PCT Filed: Mar. 14, 2002
(86) PCT No.: PCT/US02/07853

(51) Int. Cl. B60G 1/00

(52) U.S. Cl. 280/124.17

(57) ABSTRACT

A front steering axle suspension for a wheeled vehicle comprises a leaf spring (15) mounted at its ends to a vehicle frame and an axle bracket (20) mounted to the leaf spring at a central portion thereof and having inclined air spring seats (38, 40). Air spring brackets are mounted to the vehicle frame having air spring seats inclined at an angle complementary to the air spring seats of the axle bracket. An air spring is (22, 34 mounted between the axle bracket and an air spring bracket so that the air spring is inclined with respect to the vertical in a substantially vertical plane.

### RELATED APPLICATION

This application claims priority of U.S. Provisional Application No. 60/276,701, filed Mar. 16, 2001.

### BACKGROUND OF THE INVENTION

1. Technical Field of the Invention

This invention relates to truck suspensions. In one aspect, the invention relates to a front steering axle suspension with inclined air springs.

2. Description of the Related Art

Leaf spring suspensions are typically used with steering axles for trucks and semi tractors. The spring rate for such suspensions is generally high, resulting in a suspension that is relatively stiff. As the vehicle travels over an uneven roadway, jounce and vibration are transmitted to the operator. This vibration can cause operator fatigue and, over a period of time, equipment failure. While air springs can be combined with mechanical springs, such as leaf springs, to provide the stiffness desired for a front steer axle suspension with the ride-cushioning effect provided by an air spring, the air springs are vertically disposed, resulting in a suspension with a natural frequency greater than about 1 Hertz (i.e. 1 cycle per second). Vibrations greater than about 2 Hertz have been found to be uncomfortable to humans.

The U.S. Pat. No. 4,919,399 to Selzer et al. discloses a front steer axle suspension that includes a leaf spring and a vertically-disposed air spring mounted between the mid-point of the leaf spring and the vehicle frame, and centered over the steer axle.

The U.S. Pat. No. 5,755,456 to Bla\check{z}ek et al. and U.S. Pat. No. 3,003,575 to Nallinger disclose half axle suspensions with inclined air springs between the axle and the frame in a plane transverse to the longitudinal direction of the vehicle. The U.S. Pat. No. 4,854,603 to Scaduto discloses a similar suspension but using inclined damper and spring assemblies that lie in a plane transverse to the vehicle axis.

The U.S. Pat. No. 5,109,939 to Conaway et al. discloses a vibration dampening suspension for a cab of a truck in which inclined air springs are used between the cab and the frame and lie in a plane transverse to the longitudinal axis of the vehicle.

The U.S. Pat. No. 2,920,903 to Locker, U.S. Pat. No. 2,023,135 to Hawkins, U.S. Pat. No. 5,944,339 to McKenzie et al., and U.S. Pat. No. 4,530,515 to Raidel all disclose trailing arm suspensions, each of which has a trailing arm with a single inclined air spring between the trailing arm and the vehicle axis.

The U.S. Pat. No. 5,024,462 to Assh discloses a combined air and leaf spring suspension wherein an air spring is mounted on a lever at one end of the leaf spring.

The U.S. Pat. No. 3,390,895 to Verdi discloses an auxiliary axle suspension in which a pair of vertically disposed air springs is mounted between an axle bracket and a vehicle frame in a spring beam suspension.

### SUMMARY OF THE INVENTION

According to the invention, a vehicle suspension for a front steering axle comprises a leaf spring, an axle bracket mounted to the leaf spring at a central portion thereof for mounting the axle to the leaf spring, a first air spring seat inclined at an acute angle to a horizontal axis and connected to a central portion of the leaf spring, a first air spring bracket adapted to be mounted to the vehicle frame and having a second air spring seat inclined at an angle complementary to the acute angle of the first air spring seat, and a first air spring mounted between the first air spring seat and the second air spring seat. The first air spring is inclined at an acute angle with respect to the vertical in a substantially vertical plane that includes the leaf spring when the first air spring bracket is mounted to the vehicle frame.

The acute angle of the first air spring can vary and generally is between about 30 and 60 degrees with respect to the vertical, preferably, approximately 45 degrees from the vertical when the first air spring bracket is mounted to the vehicle frame.

In one embodiment, a third air spring seat, inclined at an acute angle with respect to the vertical, is connected to a central portion of the leaf spring. A second air spring bracket, adapted to be mounted to the vehicle frame, has a fourth air spring seat inclined at an angle complementary to the acute angle of the second air spring seat. A second air spring is mounted between the third air spring seat and the fourth air spring seat and is inclined at an acute angle with respect to the vertical in the substantially vertical plane when the second air spring bracket is mounted to the vehicle frame.

The natural frequency of the suspension is generally less than 2 Hertz, preferably no more than 1.2 Hertz and typically between 1 and 1.2 Hertz.

In a preferred embodiment, the first air spring seat is mounted to the axle bracket. Preferably, the third air spring seat is also mounted to the axle bracket.

In a normal configuration, the first air spring is mounted fore and the second air spring is mounted aft of the axle with the acute angles being opposite in orientation with respect to the vertical.

Further according to the invention, an air spring assembly for a wheeled vehicle suspension that is adapted to be mounted between a vehicle frame and an axle having a longitudinal axis comprises an axle bracket mounted to the axle and having a first air spring seat inclined at an acute angle to a horizontal axis perpendicular to the axle longitudinal axis, a first air spring bracket adapted to be mounted to the vehicle frame and having a second air spring seat inclined at an angle complementary to the acute angle of the first air spring seat and a first air spring mounted between the first air spring seat and the second air spring seat wherein the first air spring is inclined at an acute angle with respect to the horizontal axis in the substantially vertical plane when the first air spring bracket is mounted to the vehicle frame.

In a preferred embodiment, a third air spring seat, inclined at an acute angle with respect to the horizontal axis is also formed on the axle bracket. A second air spring bracket, adapted to be mounted to the vehicle frame, has a fourth air spring seat inclined at an angle complementary to the acute angle of the second air spring seat. A second air spring is mounted between the third air spring seat and the fourth air spring seat and is inclined at an acute angle with respect to the horizontal axis when the second air spring bracket is mounted to the vehicle frame.

The natural frequency of the suspension is generally less than 2 Hertz, preferably no more than 1.2 Hertz and typically between 1 and 1.2 Hertz.

In a normal configuration, the first air spring is mounted fore and the second air spring is mounted aft of the axle with the acute angles being opposite in orientation with respect to the vertical.

Further according to the invention, a vehicle having a longitudinal frame with a front portion having a steer axle and a rear portion has a suspension system as described above mounted between the steer axle and the longitudinal frame.

### BRIEF DESCRIPTION OF THE DRAWINGS

In the drawings:

FIG. 1 is a side elevational view of a leaf spring suspension illustrating a preferred embodiment comprising an axle bracket for mounting air springs according to the invention.

FIG. 2 is an exploded view of the axle bracket of FIG. 1.

### DETAILED DESCRIPTION OF THE EMBODIMENT

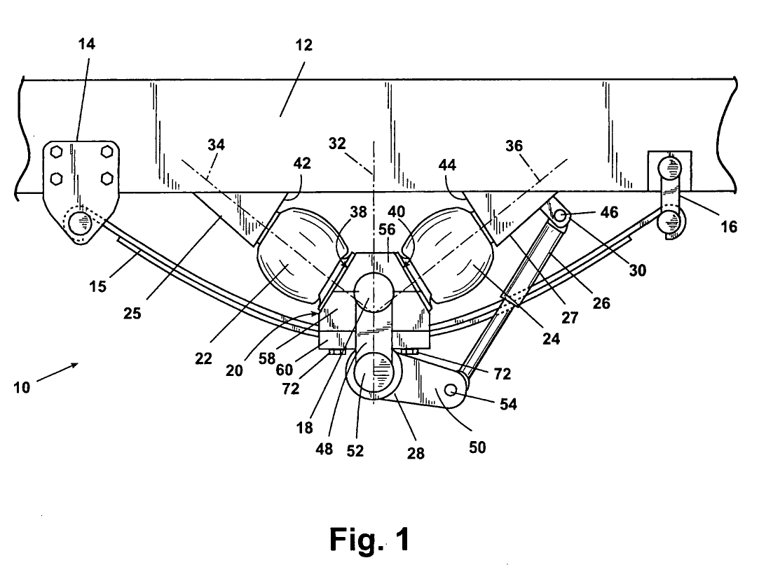

Referring now to FIG. 1, a preferred embodiment of the invention is shown comprising a leaf spring and inclined air spring suspension 10 suspended from a side rail 12. The side rail 12 is part of a conventional truck or semi tractor vehicle frame and lies in a substantially vertical plane. The front of the vehicle is to the left as viewed in FIG. 1. For the sake of simplicity, only one side of the suspension assembly 10 will be described in detail, although it is understood that each side of the vehicle has an identical portion of the assembly.

A conventional leaf spring hanger 14 is connected to the side rail 12, preferably by welding or a conventional bolted connection. A conventional spring shackle 16 is connected to the side rail 12, preferably by welding or a conventional bolted connection. A conventional front steer axle taper leaf spring 15 is suspended from the spring hanger 14 and spring shackle 16. A steer axle 18 is connected to the leaf spring 15 through an axle bracket 20.

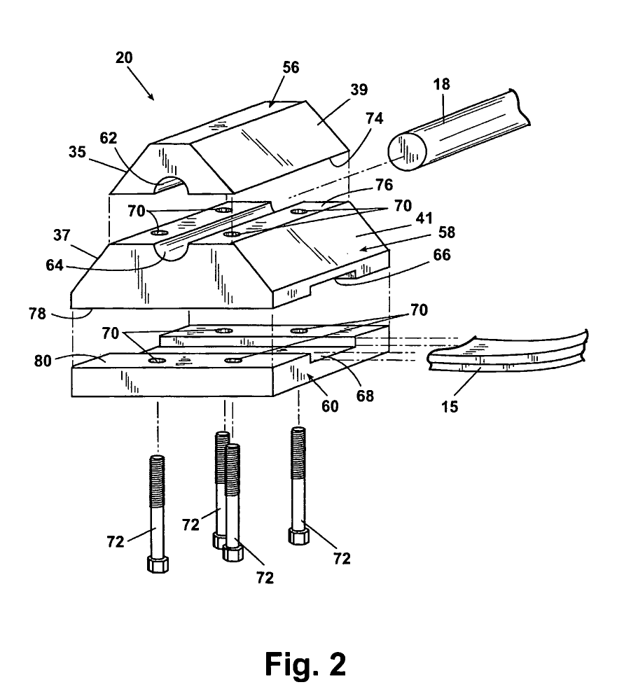

Referring to FIG. 2, the axle bracket 20 comprises a generally trapezoidal-shaped upper portion 56, a generally trapezoidal-shaped center portion 58, and a generally square or rectangular plate-like portion 60, which are assembled into the axle bracket 20. The upper portion has a first inclined face 35, a second inclined face 39, and a bottom face 74 having an upper axle channel 62 of semi-cylindrical shape extending longitudinally thereof. The center portion 58 has a first inclined face 37, a second inclined face 41, a top face 76 having a lower axle channel 64 of semi-cylindrical shape extending longitudinally thereof, and a bottom face 78 having an upper leaf spring slot 66 of rectilinear shape extending transversely thereof. The lower portion 60 has a top face 80 having a lower leaf spring slot 68 of rectilinear shape extending transversely thereof. The size and shape of the bottom face 74 are complementary to the size and shape of the top face 76. The size and shape of the bottom face 78 are complementary to the size and shape of the top face 80. The upper portion 56, the center portion 58, and the lower portion 60 are adapted to be assembled into a generally uniformly-shaped body, such as by threaded connections comprising bolts 72 and coaxially-aligned threaded apertures 70. The slots 66, 68 are adapted to matingly communicate and slidably receive the center portion of the leaf spring 15, and to rigidly hold the leaf spring 15 when the center portion 58 is clamped to the lower portion 60. The channels 62, 64 are adapted to matingly communicate, and slidably receive and rigidly hold the axle 18, when the top portion 56 is clamped to the center portion 58. When the axle bracket 20 is assembled, the faces 35, 37 form an upwardly-inclined face 38, and the faces 39, 41 form an upwardly-inclined face 40, comprising bearing surfaces for mounting a pair of air springs 22, 24. A pair of air spring mounting brackets 25, 27 with downwardly-inclined faces 42, 44 complementary to the upwardly-inclined faces 38, 40 comprising bearing surfaces 42, 44 for mounting the air springs 22, 24 are attached to the rail 12, preferably by welding or a conventional bolted connection. The inclination of the upwardly-inclined faces 38, 40 defines an acute angle with a horizontal axis in a substantially vertical plane defined by the leaf spring 15.

The air springs 22, 24 define spring axes 34, 36, respectively. The faces 38, 42 are in generally parallel spaced-apart relationship and coaxial with the air spring axis 34. The faces 40, 44 are in generally parallel spaced-apart relationship and coaxial with the air spring axis 36. The air spring 22 is mounted to the air spring bracket 25 and the axle bracket 20 between the faces 38 and 42 using conventional bolted connections (not shown). The air spring 24 is mounted to the air spring bracket 27 and the axle bracket 20 between the faces 40 and 44 using conventional bolted connections (not shown). The inclined faces 42, 44 on the air spring brackets 25, 27 and the inclined faces 38, 40 on the axle bracket 20 are oriented so that the axes 34, 36 are inclined at approximately 45 degrees from a vertical axis 32 passing through the center of the axle 18 when the air springs 22, 24 are mounted in the suspension 10.

A conventional shock absorber 26 is pivotally connected through a frame bracket 30 to the rail 12 by a conventional pivotable connection 46 at the cylinder end of the shock absorber 26. The frame bracket 30 is rigidly mounted to the air spring bracket 27, such as by welding or a conventional bolted connection. Alternatively, the frame bracket 30 can be mounted to the rail 12. The shock absorber 26 extends from the bracket 30 in a downwardly inclined direction for pivotably connecting the piston end to a shock absorber bracket 28 as hereinafter described.

A shock absorber bracket 28 is rigidly attached to the axle 18 or, alternatively to the axle bracket 20, such as by welding or a conventional bolted connection. As shown in FIG. 1, the preferred embodiment of the bracket 28 is a two-piece member comprising a drop arm 48 and a shock absorber arm 50 rigidly attached thereto through a rigid connection 52. The drop arm 48 comprises a rigid elongated member rigidly attached at one end to the axle 18 and rigidly attached at a second downwardly-extending end to the shock absorber arm 50. The shock absorber arm 50 comprises a rigid elongated member rigidly attached at one end to the drop arm 48 and having at a second end a generally conventional pivotable connection 54. The shock absorber arm 50 is disposed laterally from the drop arm 48 toward the piston end of the shock absorber 26 depending from the frame bracket 30. The piston end of the shock absorber 26 is pivotally connected to the shock absorber bracket 28 through the pinned connection 54. Alternatively, the shock absorber bracket 28 can comprises a single generally L-shaped member having the same general configuration as the two-piece bracket described herein.

As illustrated in the drawings, the air springs 22, 24 are shown as components of a front steer axle suspension 10, and are inclined approximately 45 degrees from the vertical. This orientation for two air springs has been found to reduce the natural frequency of the suspension system to between approximately 1 and 2 Hertz, which provides a substantial improvement in ride comfort as compared to systems without air springs, or using vertically-disposed air springs, thereby reducing significantly both operator fatigue and progressive equipment failure. Further adjustments of the natural frequency of the suspension system 10 can be made by adjusting the inclination of the air springs 22, 24. Thus, the inclination of the air springs with respect to the vertical can vary over a wide range, for example, from about 30 to about 60 degrees with respect to the vertical. Additionally, the combination of the inclined air springs 22, 24 with the leaf springs 15 eliminates the need for conventional suspension track bars, resulting in an overall suspension weight reduction.

FIG. 1 shows one application for the invention in which the inclined air springs 22, 24 are incorporated into a front steer axle suspension assembly 10 for a truck. The suspension assembly 10 can be incorporated into any vehicle suspension in which it is desired to reduce the frequency of vibration of the suspended structure to approximately 1 Hertz.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention.

We claim:

1. A front steering axle suspension for a wheeled vehicle comprising an axle and an elongated leaf spring adapted to be mounted at its ends in a substantially vertical plane to a vehicle frame, the improvement comprising:
an axle bracket mounted to the leaf spring at a central portion thereof for mounting the axle to the leaf spring;
a first air spring seat inclined at an acute angle to a horizontal axis and connected to a central portion of the leaf spring;
a first air spring bracket adapted to be mounted to the vehicle frame and having a second air spring seat inclined at an angle complementary to the acute angle of the first air spring seat; and
a first air spring mounted between the first air spring seat and the second air spring seat wherein the first air spring is inclined at an acute angle with respect to the vertical in the substantially vertical plane when the first air spring bracket is mounted to the vehicle frame.

2. A vehicle suspension according to claim 1 wherein the first air spring is inclined approximately 45 degrees from the vertical when the first air spring bracket is mounted to the vehicle frame.

3. A vehicle suspension according to any one of claims 1 or 2 and further comprising;
a third air spring seat inclined at an acute angle to a horizontal axis and connected to a central portion of the leaf spring;
a second air spring bracket adapted to be mounted to the vehicle frame and having a fourth air spring seat inclined at an angle complementary to the acute angle of the second air spring seat; and
a second air spring mounted between the third air spring seat and the fourth air spring seat wherein the second air spring is inclined at an acute angle with respect to the vertical in the substantially vertical plane when the second air spring bracket is mounted to the vehicle frame.

4. A vehicle suspension according to any of claims 1-3 wherein the natural frequency of the suspension is no more than 2 Hertz.

5. A vehicle suspension according to any of claims 1-3 wherein the natural frequency of the suspension is between 1 and 2 Hertz.

6. A vehicle suspension according to any of claims 1-5 wherein the first air spring seat is mounted to the axle bracket.

7. A vehicle suspension according to any of claims 3-5 wherein the first and third air spring seats are mounted to the axle bracket.

8. A vehicle suspension according to any of claims 3-7 wherein the first air spring is mounted fore and the second air spring is mounted aft of the axle.

9. An air spring assembly for a wheeled vehicle suspension that is adapted to be mounted between a vehicle frame and an axle having a longitudinal axis, the vehicle frame having a side rail lying in a substantially vertical plane, comprising:
an axle bracket mounted to the axle and having a first air spring seat inclined at an acute angle to a horizontal axis perpendicular to the axle longitudinal axis;
a first air spring bracket adapted to be mounted to the vehicle frame and having a second air spring seat inclined at an angle complementary to the acute angle of the first air spring seat; and
a first air spring mounted between the first air spring seat and the second air spring seat wherein the first air spring is inclined at an acute angle with respect to the horizontal axis in the substantially vertical plane when the first air spring bracket is mounted to the vehicle frame.

10. An inclined air spring assembly according to claim 9 wherein the first air spring is inclined approximately 45 degrees from the vertical.

11. An inclined air spring assembly according to any one of claims 9 or 10 and further comprising;
a third air spring seat mounted to the axle bracket and having a third air spring seat inclined at an acute angle to the horizontal axis but opposite in direction from the inclination of the first air spring seat;
a second air spring bracket adapted to be mounted to the vehicle frame and having a fourth air spring seat inclined at an angle complementary to the acute angle of the second air spring seat; and
a second air spring mounted between the third air spring seat and the fourth air spring seat wherein the second air spring is inclined at an acute angle opposite in direction from the first air spring with respect to the horizontal axis in the substantially vertical plane.

12. An inclined air spring assembly according to any of claims 9-11 wherein the natural frequency of the suspension is no more than 2 Hertz.

13. An inclined air spring assembly according to any of claims 9-11 wherein the natural frequency of the suspension is between 1 and 2 Hertz.

14. An inclined air spring assembly according to any of claims 9-11 wherein the first air spring is mounted fore and the second air spring is mounted aft of the axle.

15. A vehicle having a longitudinal frame with a front portion having a steer axle and a rear portion, and a suspension according to any of claims 1-14 mounted to the front portion of the vehicle frame
